(19) United States
(12) Patent Application Publication
(10) Pub. No.: US 2025/0068831 A1
(43) Pub. Date: Feb. 27, 2025

(54) TEXT ERROR CORRECTION METHOD AND APPARATUS, AND ELECTRONIC DEVICE AND MEDIUM

(71) Applicant: Suzhou MetaBrain Intelligent Technology Co., Ltd., Suzhou (CN)

(72) Inventors: Xiaochuan LI, Suzhou (CN); Yaqian ZHAO, Suzhou (CN); Rengang Li, Suzhou (CN); Zhenhua GUO, Suzhou (CN); Baoyu FAN, Suzhou (CN)

(73) Assignee: Suzhou MetaBrain Intelligent Technology Co., Ltd., Wuzhou (CN)

(21) Appl. No.: 18/725,598

(22) PCT Filed: Aug. 31, 2022
(86) PCT No.: PCT/CN2022/116249

§ 371 Date: Jun. 28, 2024

(30) Foreign Application Priority Data
Apr. 11, 2022 (CN) 202210371375.3

(51) Int. Cl. G06F 40/169; G06T 9/00; G06V 10/74; G06V 10/80

(52) U.S. Cl. CPC G06F 40/169; G06T 9/00; G06V 10/761; G06V 10/806

(57) ABSTRACT

A text error correction method and apparatus, and an electronic device and a medium. The text error correction method includes: performing image encoding on an acquired image to be analyzed, so as to obtain image features (S101); performing text encoding on acquired noisy text, so as to obtain text features (S102); performing feature comparison on the image features and the text features according to a set attention mechanism, so as to obtain an error correction signal (S103); and predicting an initial text label according to the error correction signal by using a trained decoder, so as to obtain error-corrected text information (S104).

### CROSS-REFERENCE TO RELATED APPLICATION

This application claims priority to Chinese Patent Application No. 202210371375.3, entitled “TEXT ERROR CORRECTION METHOD AND APPARATUS, AND ELECTRONIC DEVICE AND MEDIUM”, filed with the China National Intellectual Property Administration on Apr. 11, 2022, which is incorporated by reference in its entirety.

### FIELD

The present application relates to a text error correction method and apparatus, and an electronic device and a computer-readable storage medium.

### BACKGROUND

In recent years, multi modal (MM) has become an emerging study direction in the field of artificial intelligence, and fields such as visual commonsense reasoning (VCR) and visual question answering (VQA) have become key study topics in the industry. However, in the multi modal field, in the existing topics, it is generally assumed that human languages are absolutely correct in a multi modal process. However, for humans in the real world, an error in speaking is inevitable. Through experiments, it was found that when human text is replaced with error-in-speaking text in an existing multi modal task, the performance of an original model may be significantly reduced.

Determining, according to text, a position of an object described by text in an image in the image is taken as an example. An experiment shows that when standard text is input, a model might output a correct coordinate box. When noisy text is input, namely, when text generated by simulating an error in speaking a human language is input, a coordinate box output by the model has an error. In the real world, text language errors caused by errors in speaking are inevitable. Therefore, the inventors have realized that for a multi modal task, the noise resistance of a model to the text language errors has become one of the urgent topics to be studied in this field.

It might be seen that how to improve the noise resistance of the multi modal task is a problem that needs to be solved by those skilled in the art.

### SUMMARY

According to various embodiments disclosed in the present application, a text error correction method and apparatus, and an electronic device and a computer-readable storage medium are provided.

A text error correction method includes:
performing image encoding on an acquired image to be analyzed, so as to obtain image features;
performing text encoding on acquired noisy text, so as to obtain text features;
performing feature comparison on the image features and the text features according to a set attention mechanism, so as to obtain an error correction signal; and
predicting an initial text label according to the error correction signal by using a trained decoder, so as to obtain error-corrected text information.

A text error correction apparatus includes:
an image encoding unit, configured for performing image encoding on an acquired image to be analyzed, so as to obtain image features;
a text encoding unit, configured for performing text encoding on acquired noisy text, so as to obtain text features;
a feature comparison unit, configured for performing feature comparison on the image features and the text features according to a set attention mechanism, so as to obtain an error correction signal; and
a prediction unit, configured for predicting an initial text label according to the error correction signal by using a trained decoder, so as to obtain error-corrected text information.

An electronic device includes:
a memory, configured for storing computer-readable instructions; and
a processor, configured for executing the computer-readable instructions to implement the steps of the text error correction method described above.

A computer-readable storage medium has computer-readable instructions stored thereon, wherein the computer-readable instructions, when executed by one or more processors, implement the steps of any one of the text error correction methods described above.

The details of one or more embodiments of the present application are presented in the accompanying drawings and description below. Other features and advantages of the present application will become apparent from the specification, accompanying drawings, and claims.

### BRIEF DESCRIPTION OF THE DRAWINGS

For clearer descriptions of the embodiments of the present application, the drawings required to be used in the embodiments are briefly introduced below. It is obvious that the drawings in the description below are only some embodiments of the present application, and it is obvious for those skilled in the art that other drawings can be acquired according to the drawings without creative efforts.

FIG. 1 is a flowchart of a text error correction method according to one or more embodiments of the present application;

FIG. 2 is a schematic diagram of a network structure corresponding to a self-attention mechanism according to one or more embodiments of the present application;

FIG. 3 is a schematic diagram of a network structure for analyzing alignment features and text features according to one or more embodiments of the present application;

FIG. 4 is a schematic structural diagram of a text error correction apparatus according to one or more embodiments of the present application;

FIG. 5 is a schematic structural diagram of an electronic device according to one or more embodiments of the present application; and

FIG. 6 is a schematic structural diagram of a computer-readable storage medium according to one or more embodiments of the present application.

### DETAILED DESCRIPTION

The technical solutions in embodiments of the present application are clearly and completely described in the following with reference to the accompanying drawings in the embodiments of the present application. Apparently, the described embodiments are merely some rather than all of the embodiments of the present application. All other embodiments obtained by a person of ordinary skill in the art based on the embodiments of the present application without making creative efforts shall fall within the protection scope of the present application.

The terms “include”, “has”, and any variant thereof in the specification and claims of the present application and in the accompanying drawings above are intended to cover a non-exclusive inclusion. For example, a process, method, system, product, or device that includes a series of steps or units is not limited to the listed steps or units, but may include steps or units that are not listed.

To make a person skilled in the art better understand the solutions of the present application, the present application will be further explained in detail below in conjunction with the accompanying drawings and specific implementations.

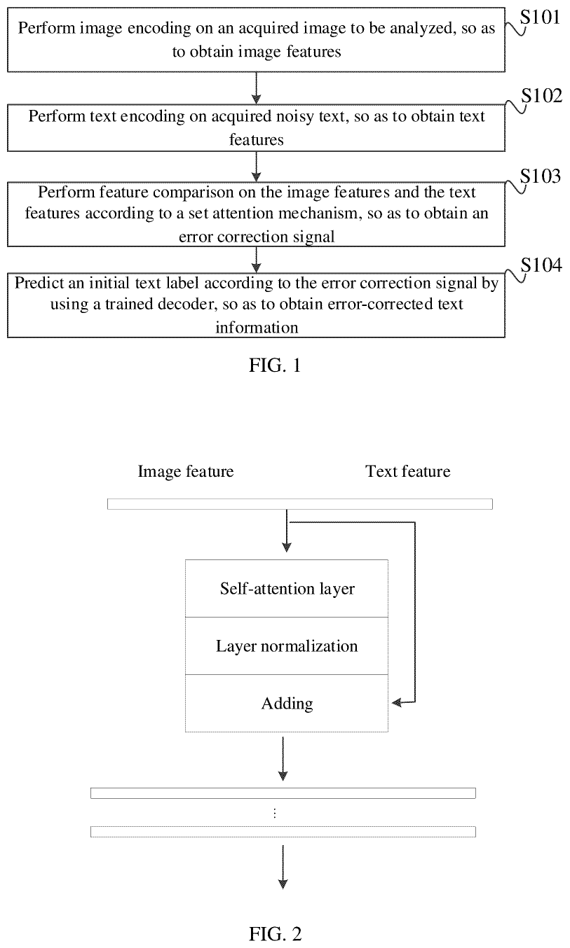

Next, a text error correction method provided by the embodiments of the present application will be introduced in detail. FIG. 1 is a flowchart of a text error correction method according to one or more embodiments of the present application. The method includes:
S101: Performing image encoding on an acquired image to be analyzed, so as to obtain image features.

Noisy text describes a target object in a written form, and the image to be analyzed may be an image containing the target object. In order to achieve emphatic analysis on the target object in the image to be analyzed, the image to be analyzed may be encoded. The image features obtained by encoding reflect features, which are strongly related to the target object, in the image to be analyzed. The image encoding mode is a relatively mature technology and will not be elaborated here.
S102: Performing text encoding on acquired noisy text, so as to obtain text features.

The noisy text may be text containing incorrect description information. For example, the image to be analyzed contains a girl wearing white clothes, and the noisy text describes “a girl wearing green clothes”.

The image features are generally presented in a matrix form. In order to achieve comparison between the image features and the noisy text, the text encoding needs to be performed on the noisy text, so as to transform the noisy text into a text feature form. The number of characters is contained in the noisy text is equal to the number of the text features.
S103: Performing feature comparison on the image features and the text features according to a set attention mechanism, so as to obtain an error correction signal.

In the embodiments of the present application, in order to correct the incorrect description information in the text features based on the image features, the attention mechanism may be used to analyze different features between the image features and the text features.

The attention mechanism may include a self-attention mechanism and a cross-attention mechanism.

In one or more embodiments, association analysis may be performed on the image features and the text features according to the self-attention mechanism, so as to obtain alignment features. The alignment features and the text features are analyzed according to the self-attention mechanism and the cross-attention mechanism, so as to obtain the error correction signal.

The alignment features may include correspondence relationships between the image features and the text features.

The correspondence relationships between the image features and the text features might be fully learned through the self-attention mechanism. A schematic diagram of a network structure corresponding to the self-attention mechanism is as shown in FIG. 2. The network structure corresponding to the self-attention mechanism includes a self-attention layer, a layer normalization module, and an adding module. After being spliced, the image features and the text features may be input to the network structure corresponding to the self-attention mechanism for encoding, thereby obtaining the final alignment features.

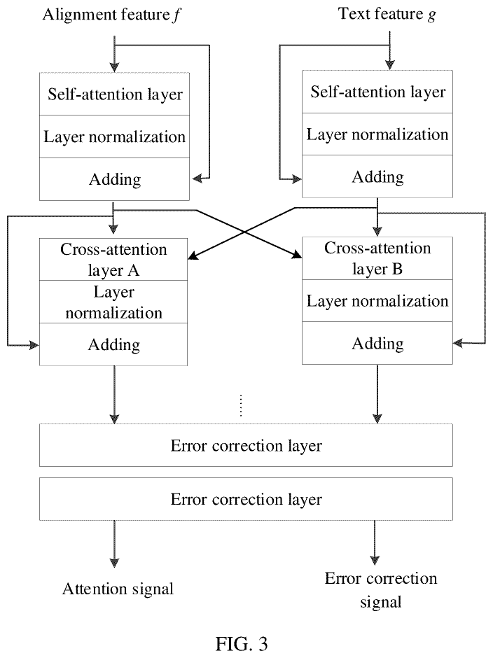

Acquiring the error correction signal is a key step for achieving text error correction. A schematic diagram of a network structure for analyzing the alignment features and the text features is as shown in FIG. 3. Attention analysis is performed respectively on the alignment features f and the text features g according to the self-attention mechanism, whereby self-attention features of the alignment features and self-attention features of the text features may be obtained. Cross-attention analysis is performed on the self-attention features of the alignment features and the self-attention features of the text features, whereby cross-attention vectors may be obtained. In order to distinguish two branches respectively corresponding to the alignment features and the text features in FIG. 3, the branch where the alignment features are located contains a cross-attentional analysis label and is labeled as cross-attention layer A, and the branch where the text features are located contains a cross-attentional analysis label and is labeled as cross-attention layer B. Layer normalization, adding, and error correction processing are performed on cross-attention vectors of the branch where the text features are located, whereby the error correction signal might be finally obtained. The error correction processing may be achieved based on superimposition of several error correction layers.
S104: Predicting an initial text label according to the error correction signal by using a trained decoder, so as to obtain error-corrected text information.

In the embodiments of the present application, the decoder may be pre-trained using some images with known correct text information. In specific implementation, a historical image, as well as historical noisy text and correct text corresponding to the historical image, may be collected. According to the operations from S101 to S103 above, the historical image and its corresponding historical noisy text are processed, so as to obtain a historical error correction signal. After the historical error correction signal is obtained, the decoder may be trained using the historical error correction signal and the correct text, so as to obtain the trained decoder.

It should be noted that after the trained decoder is obtained, the initial text label is predicted according to the error correction signal by directly using the trained decoder, without the need for training the decoder at each prediction.

The initial text label includes a starting symbol. In the embodiments of the present application, the following may be included: performing self-attention analysis on the error correction signal and the initial text label, and determining a next character adjacent to the initial text label; and adding the next character into the initial text label, returning to the step of performing self-attention analysis on the error correction signal and the initial text label, and determining a next character adjacent to the initial text label until the next character is a termination character, and using a current initial text label as error-corrected text information.

For example, it is assumed that the noisy text contains “a girl wearing a green dress”, and the image to be analyzed contains a girl wearing a white dress. The initial text label may be a character containing an initial symbol “start”. The trained decoder is used to predict the initial text label according to the error correction signal, so as to obtain “wearing”, “white”, “a dress”, and “a girl”. The decoder is used repeatedly to predict a next character until a termination character “end” is generated, indicating the end of the prediction process. At this time, “a girl wearing a white dress” obtained is the error-corrected text information.

From the above technical solution, it might be seen that the image encoding is performed on the acquired image to be analyzed, so as to obtain the image features. The image features reflect the features, which are strongly related to the target object, in the image to be analyzed. The noisy text describes the target object in the written form. The noisy text contains the incorrect description information. To correct errors in the noisy text, the text encoding may be performed on the acquired noisy text, so as to obtain the text features. According to the set attention mechanism, the image features and the text features are compared, so as to obtain the error correction signal. The error correction signal contains different features between the text features and the image features, and text information represented by the noisy text. The initial text label is predicted according to the error correction signal by using the trained decoder, whereby the error-corrected text information may be obtained. In this technical solution, the noisy text might be corrected by the features represented by the image to obtain text containing correct information, thereby reducing the impact of the incorrect description information in the noisy text on model performance and improving the noise resistance of a multi modal task.

In one or more embodiments, the self-attention mechanism has its corresponding attention calculation formula. The self-attention vectors of both the image features and the text features are determined according to the following formula (1), wherein the self-attention vectors include associated features between each dimension of feature of the image features and each dimension of feature of the text features.

$$attention ( f ) = soft max ( \frac{{( {W}_{q} \cdot f )}^{T} \times ( {W}_{k} \cdot f )}{\sqrt{size ( f )}} ) \times ( {W}_{v} \cdot f ) ; \qquad ( 1 )$$

$$where$$

$$soft max ( x ) = \frac{{e}^{x}}{{\sum }_{j = 1}^{n} {e}^{x}} ,$$

x represents

$$( \frac{{( {W}_{q} \cdot f )}^{T} \times ( {W}_{k} \cdot f )}{\sqrt{size ( f )}} ) ;$$

f represents the spliced image features and text features; and W_{q}, Wₖ, and Wᵥ are all model parameters obtained by model training; and
layer normalization and adding processing are performed on the self-attention vectors, so as to obtain the alignment features.

The analysis process of the alignment features and the text features may include: performing attention analysis on the alignment features according to the self-attention mechanism, so as to obtain self-attention features of the alignment features; performing attention analysis on the text features according to the self-attention mechanism, so as to obtain self-attention features of the text features; determining cross-attention vectors between the self-attention features of the alignment features and the self-attention features of the text features according to the following formula (2),

$${attention}_{A} ( f , g ) = soft max ( \frac{{( {W}_{q} \cdot f )}^{T} \times ( {W}_{k} \cdot g )}{\sqrt{size ( g )}} ) \times ( {W}_{v} \cdot g ) , \qquad ( 2 )$$

where f represents the self-attention vectors of the alignment features; g represents the self-attention vectors of the text features; and W_{q}, Wₖ, and Wᵥ are all model parameters obtained by model training; and
performing layer normalization, adding, and error correction processing on the cross-attention vectors, so as to obtain the error correction signal.

Considering that there are usually a few of characters that need to be corrected in the noisy text, if most of characters in a sentence are incorrect, error correction may not be achieved because incorrect characters might not be found out according to correct characters. On the other hand, the error correction signal represents a direction of sentence correction, so it is necessary to control the features of most characters to be zero in this direction. Therefore, in the embodiments of the present application, a threshold attention mechanism may be designed to control generation of a text error correction signal. That is, in addition to calculating the cross-attention vectors according to the above formula (2), in the embodiments of the present application, a threshold attention mechanism may also be set, and corresponding formulas include Formula (3) and Formula (4).

In specific implementation, the cross-attention vectors between the self-attention features of the alignment features and the self-attention features of the text features may be determined according to the following formulas (3) and (4),

$$attention \text{?} ( f , g ) = thresh - relu ( soft max ( \frac{( {W}_{q} \cdot f ) {\text{?}}^{} \times ( {W}_{k} \cdot f )}{\sqrt{size ( g )}} ) \times ( {W}_{v} \cdot g ) ; \qquad ( 3 )$$

$$thresh - relu ( x ) = \{ \begin{matrix}0 , x < thresh \\ x , x \geq thresh\end{matrix} ; \qquad ( 4 )$$

$$\text{?} \text{indicates text missing or illegible when filed}$$

where x represents

$$\text{?} ( soft max ( \frac{{( {W}_{q} \cdot f )}^{T} \times ( {W}_{k} \cdot f )}{\sqrt{size ( g )}} ) \times ( {W}_{v} \cdot f ) ;$$

$$\text{?} \text{indicates text missing or illegible when filed}$$

f represents the self-attention vectors of the alignment features; g represents the self-attention vectors of the text features; W_{q}, Wₖ, and Wᵥ are all model parameters obtained by model training; and thresh represents a set threshold; and layer normalization, adding, and error correction processing are performed on the cross-attention vectors, so as to obtain the error correction signal.

In the embodiments of the present application, the threshold attention mechanism is configured for generating the error correction signal, which might further strengthen text features strongly related to the image features and weaken text features weakly related to the image features, thereby achieving the purpose of correction.

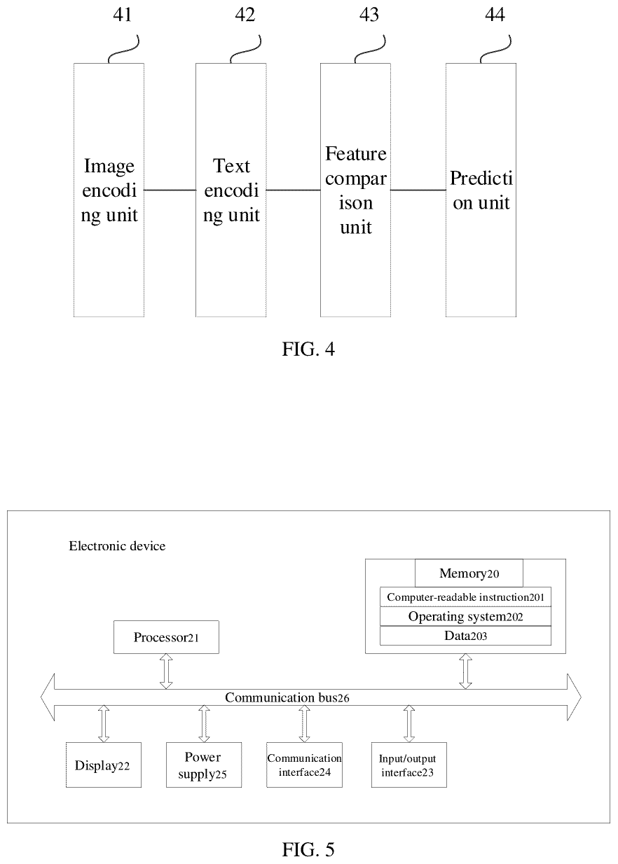

FIG. 4 is a schematic structural diagram of a text error correction apparatus according to the embodiments of the present application, including an image encoding unit 41, a text encoding unit 42, a feature comparison unit 43, and a prediction unit 44.

The image encoding unit 41 is configured for performing image encoding on an acquired image to be analyzed, so as to obtain image features;
the text encoding unit 42 is configured for performing text encoding on acquired noisy text, so as to obtain text features;
the feature comparison unit 43 is configured for performing feature comparison on the image features and the text features according to a set attention mechanism, so as to obtain an error correction signal; and
the prediction unit 44 is configured for predicting an initial text label according to the error correction signal by using a trained decoder, so as to obtain error-corrected text information.

In one or more embodiments, the attention mechanism includes a self-attention mechanism and a cross-attention mechanism;
the feature comparison unit includes a first analysis subunit and a second analysis subunit;
the first analysis subunit is configured for performing association analysis on the image features and the text features according to the self-attention mechanism, so as to obtain alignment features, wherein the alignment features include correspondence relationships between the image features and the text features; and
the second analysis subunit is configured for analyzing the alignment features and the text features according to the self-attention mechanism and the cross-attention mechanism, so as to obtain the error correction signal.

In one or more embodiments, the first analysis subunit is configured for: determining self-attention vectors of both the image features and the text features according to the following formula, wherein the self-attention vectors include associated features between each dimension of feature of the image features and each dimension of feature of the text features;

$$attention ( f ) = soft max ( \frac{{( {W}_{q} \cdot f )}^{T} \times ( {W}_{k} \cdot f )}{\sqrt{size ( f )}} ) \times ( {W}_{v} \cdot f ) ;$$

$$where$$

$$soft max ( x ) = \frac{{e}^{x}}{{\sum }_{j = 1}^{n} {e}^{x}} ,$$

x represents

$$( \frac{{( {W}_{q} \cdot f )}^{T} \times ( {W}_{k} \cdot f )}{\sqrt{size ( f )}} ) ;$$

f represents the spliced image features and text features; and W_{q}, Wₖ, and W_{y} are all model parameters obtained by model training; and
performing layer normalization and adding processing on the self-attention vectors, so as to obtain the alignment features.

In one or more embodiments, the second analysis subunit is configured for: performing attention analysis on the alignment features according to the self-attention mechanism, so as to obtain self-attention features of the alignment features;
performing attention analysis on the text features according to the self-attention mechanism, so as to obtain self-attention features of the text features;
determining the cross-attention vectors between the self-attention features of the alignment features and the self-attention features of the text features according to the following formula,

$${attention}_{A} ( f , g ) = soft max ( \frac{{( {W}_{q} \cdot f )}^{T} \times ( {W}_{k} \cdot g )}{\sqrt{size ( g )}} ) \times ( {W}_{v} \cdot g ) ,$$

where f represents the self-attention vectors of the alignment features; g represents the self-attention vectors of the text features; and W_{q}, Wₖ, and W_{y} are all model parameters obtained by model training; and
performing layer normalization, adding, and error correction processing on the cross-attention vectors, so as to obtain the error correction signal.

In one or more embodiments, the second analysis subunit is configured for: performing attention analysis on the alignment features according to the self-attention mechanism, so as to obtain self-attention features of the alignment features;
performing attention analysis on the text features according to the self-attention mechanism, so as to obtain self-attention features of the text features;
determining the cross-attention vectors between the self-attention features of the alignment features and the self-attention features of the text features according to the following formula,

$${attention}_{B} ( g , f ) = thresh - relu ( soft max ( \frac{{( {W}_{q} \cdot g )}^{T} \times ( {W}_{k} \cdot f )}{\sqrt{size ( g )}} ) \times ( {W}_{v} \cdot f ) ) ;$$

$$thresh - relu ( x ) = \{ \begin{matrix}0 , x < thresh \\ x , x \geq thresh\end{matrix} ;$$

where x represents

$$\text{?} ( soft max ( \frac{{( {W}_{q} \cdot f )}^{T} \times ( {W}_{k} \cdot f )}{\sqrt{size ( g )}} ) \times ( {W}_{v} \cdot f ) ) ;$$

$$\text{?} \text{indicates text missing or illegible when filed}$$

f represents the self-attention vectors of the alignment features; g represents the self-attention vectors of the text features; W_{q}, Wₖ, and Wᵥ are all model parameters obtained by model training; and thresh represents a set threshold; and performing layer normalization, adding, and error correction processing on the cross-attention vectors, so as to obtain the error correction signal.

In one or more embodiments, the initial text label includes a starting symbol.

The prediction unit includes a determining subunit and an adding subunit;
the determining subunit is configured for: performing self-attention analysis on the error correction signal and the initial text label, and determining a next character adjacent to the initial text label; and
the adding subunit is configured for: adding the next character into the initial text label, returning to the step of performing self-attention analysis on the error correction signal and the initial text label, and determining a next character adjacent to the initial text label until the next character is a termination character, and using a current initial text label as error-corrected text information.

In one or more embodiments, for a training process of a decoder, the apparatus includes an acquisition unit and a training unit.

The acquisition unit is configured for acquiring a historical error correction signal and correct text corresponding to the historical error correction signal; and
the training unit is configured for training the decoder by using the historical error correction signal and the correct text, so as to obtain the trained decoder.

The specific limitations on the text error correction apparatus may be found in the text error correction method above, and will not be elaborated here. The various units in the above text error correction apparatus may be achieved entirely or partially through software, hardware, and a combination of software and hardware. The above units might be embedded in or independent of a processor in a computer device in a hardware form, or stored in a memory in the computer device in a software form, for the processor to invoke and execute the operations corresponding to the above units.

From the above technical solution, it might be seen that the image encoding is performed on the acquired image to be analyzed, so as to obtain the image features. The image features reflect the features, which are strongly related to the target object, in the image to be analyzed. The noisy text describes the target object in the written form. The noisy text contains the incorrect description information. To correct errors in the noisy text, the text encoding may be performed on the acquired noisy text, so as to obtain the text features. According to the set attention mechanism, the image features and the text features are compared, so as to obtain the error correction signal. The error correction signal contains different features between the text features and the image features, and text information represented by the noisy text. The initial text label is predicted according to the error correction signal by using the trained decoder, whereby the error-corrected text information may be obtained. In this technical solution, the noisy text might be corrected by the features represented by the image to obtain text containing correct information, thereby reducing the impact of the incorrect description information in the noisy text on model performance and improving the noise resistance of a multi modal task.

FIG. 5 is a schematic structural diagram of an electronic device according to the embodiments of the present application. As shown in FIG. 5, the electronic device includes:
a memory 20, configured for storing computer-readable instructions 201; and
one or more processors 21, configured for executing the computer-readable instructions 201 to implement the steps of the text error correction method in any one of the above embodiments.

The electronic device of this embodiment may include but is not limited to a smart phone, a tablet, a laptop, a desktop computer, or the like.

The processor 21 may include one or more processing cores, such as a 4-core processor and an 8-core processor. The processors 21 may be implemented in at least one hardware form, including Digital Signal Processing (DSP), a Field-Programmable Gate Array (FPGA), and a Programmable Logic Array (PLA). The processors 21 may also include a main processor and a coprocessor. The main processor is a processor configured for processing data in an awake state is also referred to as a Central Processing Unit (CPU). The coprocessor is a low-power processor configured for processing data in a standby state. In some embodiments, the processors 21 may be integrated with a Graphics Processing Unit (GPU). The GPU is configured for rendering and drawing content that needs to be displayed on a display screen. In some embodiments, the processors 21 may further include an Artificial Intelligence (AI) processor. The AI processor is configured for processing computing operations related to machine learning.

The memory 20 may include one or more computer-readable storage media. The computer-readable storage medium may be non-transitory. The memory 20 may also include high-speed random access memory and a non-volatile memory, such as one or more magnetic storage devices and flash storage devices. In this embodiment, the memory 20 is at least configured for storing the following computer-readable instructions 201, wherein after being loaded and executed by the processors 21, the computer-readable instructions 201 might implement the relevant steps in the text error correction method disclosed in any one of the aforementioned embodiments. In addition, resources stored in the memory 20 may also include an operating system 202 and data 203, and a storage mode may be temporary storage or permanent storage. The operating system 202 may include Windows, Unix, Linux, and the like. The data 203 may include but is not limited to image features, text features, attention mechanisms, and the like.

In some embodiments, the electronic device may further include a display screen 22, an input/output interface 23, a communication interface 24, a power supply 25, and a communication bus 26.

A person skilled in the art may understand that the structures shown in FIG. 5 impose no limitation on the electronic device, and may include more or fewer components than those shown in the figure.

It should be understood that if the text error correction method the above embodiments are implemented in a form of a software functional unit and sold or used as a stand-alone product, the text error correction method may be stored in a computer-readable storage medium. Based on this understanding, the technical solutions of the present application essentially, or the part that contributes to the prior art, or all or some of the technical solutions, might be reflected in the form of a software product. The computer software product is stored in a storage medium to execute all or some of the steps of the methods in the various embodiments of the present application. The aforementioned storage medium includes: a USB flash disk, a portable hard disk drive, a Read-Only Memory (ROM), a Random Access Memory (RAM), an electrically erasable programmable ROM, a register, a hard disk drive, a removable magnetic disk, a Compact disc ROM (CD-ROM), a magnetic tape or an optical disc, and other media that might store program codes.

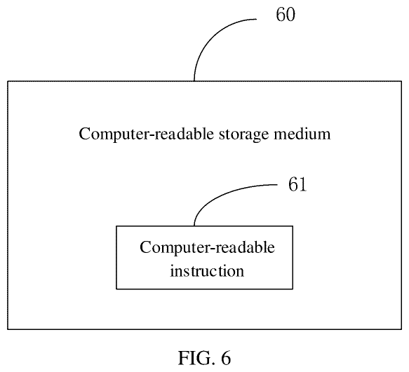

In one or more embodiments, the embodiments of the present application further provide a computer-readable storage medium. As shown in FIG. 6, the computer-readable storage medium 60 has computer-readable instructions 61 stored thereon. The computer-readable instructions 61, when executed by one or more processors, implement the steps of the text error correction method as described in any one of the above embodiments.

The functions of the various functional modules of the computer-readable storage medium according to the embodiments of the present application may be in some embodiments implemented according to the method in the above method embodiment, and specific implementation processes thereof may be found in the relevant description of the above method embodiment. They will not be elaborated here.

The text error correction method and apparatus, and the electronic device and the computer-readable storage medium provided by the embodiments of the present application have been introduced in detail above. The various embodiments in this specification are described in a progressive manner, and each embodiment focuses on differences from other embodiments. The same and similar parts between all the embodiments might be referred to each other. Since the apparatus disclosed in the embodiments correspond to the method disclosed in the embodiments, the apparatus is described simply, and related parts are found in some of the explanations of the method.

A person skilled in the art may further realize that units and algorithm steps of all the examples described in the foregoing embodiments disclosed herein may be implemented by electronic hardware, computer software, or a combination thereof. To clearly describe the interchangeability between the hardware and the software, the foregoing has generally described compositions and steps of each example based on functions. Whether these functions are implemented as hardware or software depends on particular application and design constraint conditions of the technical solutions. A person skilled in the art may use different methods to implement the described functions for each particular application, but it should not be considered that the implementation goes beyond the scope of the present application.

The text error correction method and apparatus, and the electronic device and the computer-readable storage medium provided by the present application have been introduced in detail above. The principles and implementations of the present application are explained herein with specific examples, and the explanations of the above embodiments are only used to help understand the method of the present application and a core idea of the method. It should be pointed out that a person of ordinary skill in the art might also make several improvements and modifications to the present application without departing from the principles of the present application, and these improvements and modifications also fall within the scope of protection of the claims of the present application.

1. A text error correction method, comprising:
performing image encoding on an acquired image to be analyzed, so as to obtain image features;
performing text encoding on acquired noisy text, so as to obtain text features;
performing feature comparison on the image features and the text features according to a set attention mechanism, so as to obtain an error correction signal; and
predicting an initial text label according to the error correction signal by using a trained decoder, so as to obtain error-corrected text information.

2. The method according to claim 1, wherein a number of the text features is the same as a number of characters comprised in the noisy text.

3. The method according to claim 1, wherein the attention mechanism comprises a self-attention mechanism and a cross-attention mechanism; and the performing feature comparison on the image features and the text features according to a set attention mechanism, so as to obtain an error correction signal comprises:
performing association analysis on the image features and the text features according to the self-attention mechanism, so as to obtain alignment features; and
analyzing the alignment features and the text features according to the self-attention mechanism and the cross-attention mechanism, so as to obtain the error correction signal.

4. The method according to claim 3, wherein the alignment features comprise correspondence relationships between the image features and the text features.

5. The method according to claim 3, wherein the self-attention mechanism comprises a self-attention layer, a layer normalization module, and an adding module.

6. The method according to claim 3, wherein the performing association analysis on the image features and the text features according to the self-attention mechanism, so as to obtain alignment features comprises:
splicing the image features with the text features, inputting spliced image features and text features to the self-attention mechanism for encoding, so as to obtain the alignment features output by the self-attention mechanism.

7. The method according to claim 3, wherein the performing association analysis on the image features and the text features according to the self-attention mechanism, so as to obtain alignment features comprises:
determining self-attention vectors of the image features and the text features; and
performing layer normalization and adding processing on the self-attention vectors, so as to obtain the alignment features.

8. The method according to claim 7, wherein the self-attention vectors comprise associated features between each dimension of feature of the image features and each dimension of feature of the text features.

9. The method according to claim 8, wherein the determining self-attention vectors of the image features and the text features comprises:
determining the self-attention vectors of the image features and the text features according to the following formulas:
$$attention ( f ) = soft max ( \frac{{( {W}_{q} \cdot f )}^{T} \times ( {W}_{k} \cdot f )}{\sqrt{size ( f )}} ) \times ( {W}_{v} \cdot f ) ;$$
wherein
$$soft max ( x ) = \frac{{e}^{x}}{{\sum }_{j = 1}^{n} {e}^{x}} ,$$
f represents the spliced image features and text features; and W_{q}, Wₖ, and Wᵥ are model parameters obtained by model training.

10. The method according to claim 3, wherein the analyzing the alignment features and the text features according to the self-attention mechanism and the cross-attention mechanism, so as to obtain the error correction signal comprises:
performing attention analysis on the alignment features according to the self-attention mechanism, so as to obtain self-attention features of the alignment features;
performing attention analysis on the text features according to the self-attention mechanism, so as to obtain self-attention features of the text features;
determining cross-attention vectors between the self-attention features of the alignment features and the self-attention features of the text features; and
performing layer normalization, adding, and error correction processing on the cross-attention vectors, so as to obtain the error correction signal.

11. The method according to claim 10, wherein the error correction processing is achieved based on superimposition of a plurality of error correction layers.

12. The method according to claim 10, wherein the determining cross-attention vectors between the self-attention features of the alignment features and the self-attention features of the text features comprises:
determining the cross-attention vectors between the self-attention features of the alignment features and the self-attention features of the text features according to the following formula:
$${attention}_{A} ( f , g ) = soft max ( \frac{{( {W}_{q} \cdot f )}^{T} \times ( {W}_{k} \cdot g )}{\sqrt{size ( g )}} ) \times ( {W}_{v} \cdot g ) ;$$
wherein f represents the self-attention vectors of the alignment features; g represents the self-attention vectors of the text features; and W_{q}, Wₖ, and Wᵥ are model parameters obtained by model training.

13. The method according to claim 10, wherein the determining cross-attention vectors between the self-attention features of the alignment features and the self-attention features of the text features comprises:
setting a threshold attention mechanism, and determining the cross-attention vectors between the self-attention features of the alignment features and the self-attention features of the text features through the threshold attention mechanism.

14. The method according to claim 10, wherein the determining cross-attention vectors between the self-attention features of the alignment features and the self-attention features of the text features comprises:
determining the cross-attention vectors between the self-attention features of the alignment features and the self-attention features of the text features according to the following formula:
$$attention \text{?} ( g , f ) = thresh - relu ( soft max ( \frac{{( {W}_{q} \cdot g )}^{T} \times ( {W}_{k} \cdot f )}{\sqrt{size ( g )}} ) \times ( {W}_{v} \cdot f ) ) ;$$
$$\text{?} \text{indicates text missing or illegible when filed}$$
wherein
$$thresh - relu ( x ) = \{ \begin{matrix}0 , x < thresh \\ x , x \geq thresh\end{matrix} ,$$
f represents the self-attention vectors of the alignment features; g represents the self-attention vectors of the text features; W_{q}, Wₖ, and W_{y} are model parameters obtained by model training; and thresh represents a set threshold.

15. The method according to claim 1, wherein the initial text label comprises a starting symbol; and the predicting an initial text label according to the error correction signal by using a trained decoder, so as to obtain error-corrected text information comprises:
performing self-attention analysis on the error correction signal and the initial text label, and determining a next character adjacent to the initial text label; and
adding the next character into the initial text label, returning to a step of performing self-attention analysis on the error correction signal and the initial text label, and determining a next character adjacent to the initial text label until the next character is a termination character, and using a current initial text label as error-corrected text information to update the acquired noisy text.

16. The method according to claim 1, further comprising:
training a decoder to obtain the trained decoder.

17. The method according to claim 16, wherein the training the decoder comprises:
acquiring a historical error correction signal and correct text corresponding to the historical error correction signal; and
training the decoder by using the historical error correction signal and the correct text, so as to obtain the trained decoder.

18. (canceled)

19. An electronic device, comprising:
a memory storing computer-readable instructions; and
one or more processors, configured to execute the computer-readable instructions and upon execution of the computer-readable instructions, the one or more processors is configured to:
perform image encoding on an acquired image to be analyzed, so as to obtain image features;
perform text encoding on acquired noisy text, so as to obtain text features;
perform feature comparison on the image features and the text features according to a set attention mechanism, so as to obtain an error correction signal; and
predict an initial text label according to the error correction signal by using a trained decoder, so as to obtain error-corrected text information.

20. A non-transitory computer-readable storage medium, storing computer-readable instructions, wherein the computer-readable instructions are executable by one or more processors, and upon execution by the one or more processors, the computer-readable instructions are configured to cause the one or more processors to:
perform image encoding on an acquired image to be analyzed, so as to obtain image features;
perform text encoding on acquired noisy text, so as to obtain text features;
perform feature comparison on the image features and the text features according to a set attention mechanism, so as to obtain an error correction signal; and
predict an initial text label according to the error correction signal by using a trained decoder, so as to obtain error-corrected text information.

21. The method according to claim 1, further comprising:
updating text information in the acquired noisy text in input samples of a Multi Modal learning model with text information corresponding to the initial text label with is predicted.
